(19) United States
(12) Patent Application Publication
(10) Pub. No.: US 2012/0006439 A1
(43) Pub. Date: Jan. 12, 2012

(54) METHOD AND MEANS FOR FORMING A LINER

(75) Inventor: LARRY W. KIEST, JR., Ottawa, IL (US)

(73) Assignee: LMK ENTERPRISES, INC., Ottawa, IL (US)

(21) Appl. No.: 12/832,602

(22) Filed: Jul. 8, 2010

(51) Int. Cl. F16L 55/16; B32B 37/12; B29C 65/62; B32B 37/02

(52) U.S. Cl. 138/98; 156/305; 156/294; 156/93; 156/229

(57) ABSTRACT

A new liner and method of forming a liner for use in lining the junction between a main pipe and a lateral pipe are provided. A liner tube is joined about one end to a liner member about an aperture in the liner member. A liquid thermoset adhesive is applied around a junction formed between the liner tube and the liner member on a resin impermeable coated side of the liner tube and the liner member. The thermoset adhesive is not affected by temperature changes present during an exothermic reaction when the resin impregnated liner tube and liner member are cured and hardened.

### FIELD OF THE INVENTION

The present invention relates a method and means for forming a liner for use in lining the junction between a main pipe and a lateral or branch pipe, such as in sewer pipeline repair.

### BACKGROUND OF THE INVENTION

One method of repairing the junction between main and lateral sewer pipelines is shown in U.S. Pat. No. 6,039,079. A liner assembly, as shown in FIG. 3 of the patent, includes a lateral liner 26 connected to a flat sheet liner 28. Both liners 26, 28 are formed of felt or other resin absorbent material. The resin is absorbed into both liners in an uncured state and the liners are held in place in the host pipelines as the resin is cured and hardened to form a hardened liner.

Lateral liner 26 is formed by connecting side edges of a sheet of liner material with a polymer coating 30 on the exterior side. The edges are sewn together at a seam and a strip of polymer tape 34 is welded over the seam to form an airtight seal. Flat sheet liner 28 has a central aperture therein and is sewn to one end of the lateral liner 26 around the aperture. Then a strip of polymer tape 38 is folded along its length and welded continuously around the juncture to form an airtight seal.

This method of forming a liner leaves room for improvement. The tape 38 is thermoplastic, which allows it to be applied using heat in a welding operation. The use of a thermal plastic tape, while normally sufficient, can be problematic when the tape is exposed to a heat source such as steam or from an exothermic reaction of the resin as it cures and hardens. This could result in the tape disbanding from the liner.

There are also structural limitations inherent in tape that can be improved upon in sealing the liner junction. In specific, it is difficult to fold the tape in half and wrap it around the liner junction—one half of the tape on the lateral liner and the other half on the flat sheet liner—without either creating wrinkles in the flat sheet liner or cutting slits in the tape on the flat sheet liner for relief. Either condition risks compromising the airtight seal.

Still further yet, the tape is applied while the liners are in an unstretched state. It is common to slightly undersize the liner so that when stretched the liner conforms to the interior of the host pipe without wrinkling. However, stretching the liner can compromise the structural integrity of the tape, which was applied to the liner in an un-stretched state.

Therefore, it is an object of the present invention to provide an improved main/lateral liner and a means and method for forming the liner to provide an airtight seal between the main and lateral portions of the liner.

### SUMMARY OF THE INVENTION

One aspect of the invention includes a new method of forming a liner for use in lining the junction between a main pipe and a lateral pipe. The method generally includes taking a liner tube having a first end and an opposite second end and joining the first end of the liner tube to a liner member about an aperture in the liner member. The liner tube has a resin impermeable coated liner tube surface opposite an absorbent material liner tube surface, and the liner member has a resin impermeable coated liner member surface opposite an absorbent material liner member surface. A liquid thermoset adhesive is applied around a junction formed between the resin impermeable coated liner tube surface and the resin impermeable coated liner member surface, and the adhesive is cured. In a preferred form, the liquid thermoset adhesive has sufficiently high viscosity so as not to run along the liner tube or the liner member and is curable with exposure to a curing agent. It is also preferred that the liner member be a flat sheet liner that can be formed in a tubular shape.

Another aspect of the invention includes forming a liner for use in lining the junction between a main pipe and a lateral pipe wherein a main/lateral liner is stretched radially outwardly around a junction formed between the main or lateral portions of the liner. A liquid thermoset adhesive is applied around the junction between the resin impermeable coated lateral and main portions of the liner while the liner assembly is in a stretched condition. In a preferred form, the main/lateral liner assembly is stretched using an inflation device inserted through an aperture in the main portion of the liner and at least partially into the lateral portion of the liner. It is also preferred that the inflation device extend from a rotatable table upon which the main/lateral liner assembly can be mounted to facilitate both the application and curing of the liquid adhesive.

Another aspect of the invention includes a new main/lateral liner formed from a liner member and liner tube as previously discussed with a liquid thermoset adhesive disposed about a junction between the liner tube and the liner member.

Those skilled in the art having the benefit of the disclosure contained herein will appreciate many of the benefits of the various aspects of the present invention. For example, a thermoset adhesive is not affected by temperature changes present during the resin curing process. Applying the adhesive in a liquid state also allows the adhesive to be applied where necessary and avoids the inherent structural limitations of using tape. In addition, one aspect of the invention includes applying the adhesive while the liner is stretched as it would be when expanded against the interior of the host pipe, which helps avoid the risk that the adhesive will loose its structural integrity. These as well as other advantages of the invention will become apparent from the following detailed disclosure of preferred embodiments.

### BRIEF DESCRIPTION OF THE DRAWINGS

FIG. 1 is a perspective view of the main/lateral liner assembly of the present invention having an adhesive applied to the junction between the main and lateral portions of the liner.

FIG. 2 is a sectional view of the apparatus shown in FIG. 1, but showing an adhesive bottle applying the adhesive.

FIG. 3 is a sectional view of a modification in which an inflatable plug and rotating table are utilized in combination with an ultraviolet light which cures the adhesive.

### DETAILED DESCRIPTION OF THE PREFERRED EMBODIMENT

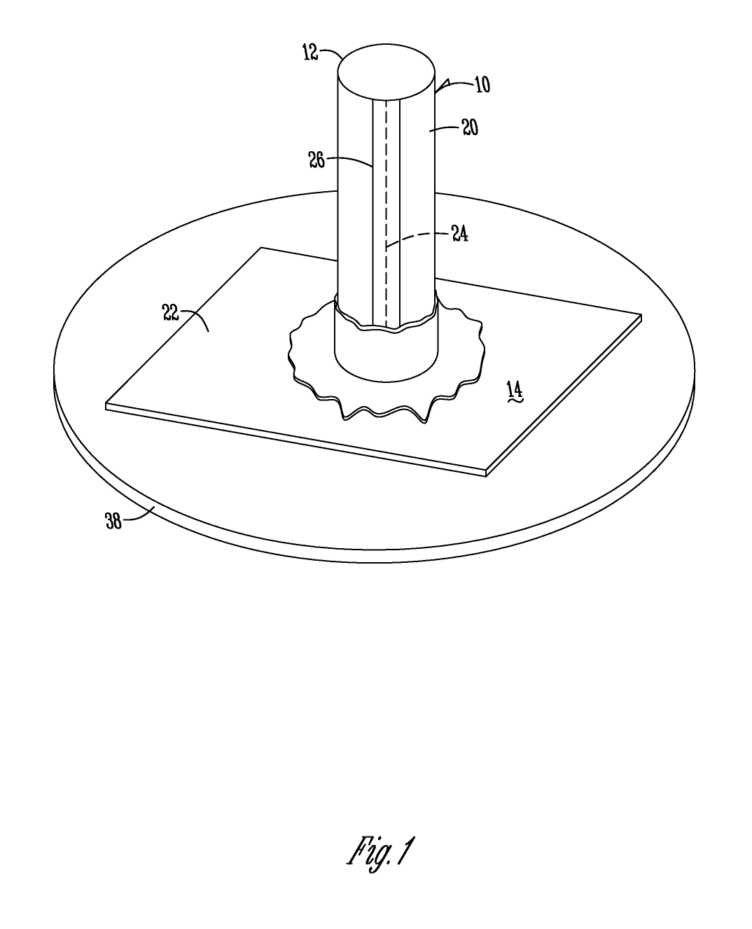

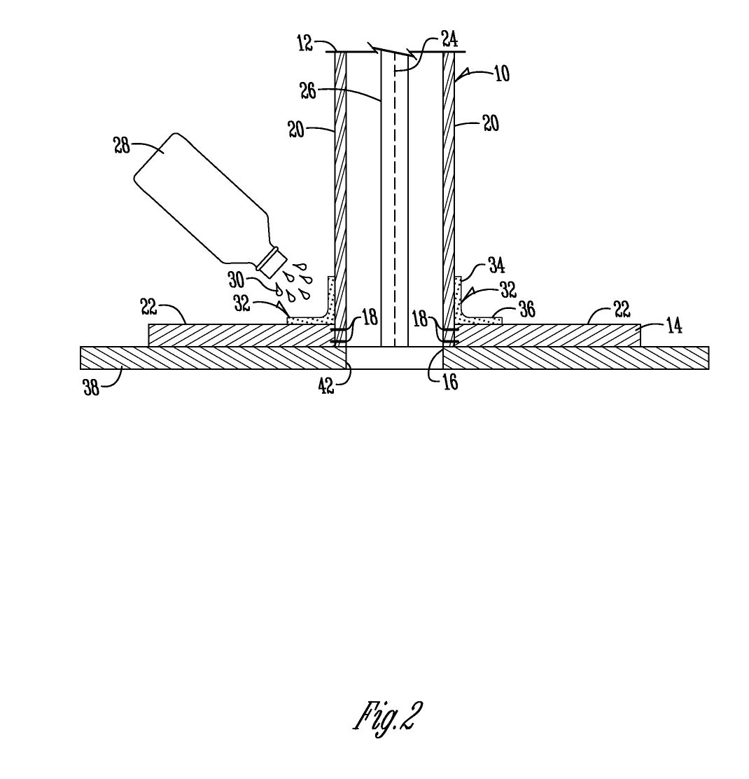

Referring to FIGS. 1-3, a main/lateral liner assembly 10 is shown made of a felt or other material that can be impregnated with a curable and hardenable material. The liner assembly 10 includes a lateral liner 12 and a main liner member 14. The main liner 14 preferably starts as a flat sheet liner and is formed into a cylinder (not shown) prior to installation. The main liner member 14 preferably forms a tubular shape for installation, but a main liner member 14 formed as a rim or collar can also be used.

The ultimate repair is preferably accomplished by impregnating the liner assembly 10 with a resinous material capable of curing and hardening that contains an exothermic reaction agent therein. The exothermic reaction agent cures and hardens the liner assembly 10 in response to introduction of heat, ultraviolet light or other devices. The result is a hardened liner assembly 10 that has both a main and lateral portion that intersect and are communicated with one another.

The lateral liner 12 is formed into a cylinder or other shape that fits aperture 16 in the main liner member 14. The lateral liner 12 is then stitched in a line of stitching 24 to conform to its cylindrical or other shape, and a polymer tape 26 is adhered or welded over the stitches to create an airtight seal.

The lateral liner 12 is then attached to the main liner member 14 with stitches 18 that extend through the aperture 16 in the main liner member 14. A resin impermeable coating 20 extends on the exterior of the lateral liner 12 and a resin impermeable coating 22 extends on the upper horizontal surface of the main liner member 14. It is preferred that the resin impermeable coating is a polymer, but other compositions having similar characteristics may be used as well. The lateral liner 12 is stitched to the main liner member 14 with the coating sides 20, 22 both on the exterior. The interior of the tubed lateral liner 12 and the bottom side of the main liner member 14 are comprised of a material which is suitable to soak up and absorb a resinous material capable of curing and hardening. An example of such an absorbent material is felt, or a felt-like material. The resin impermeable coatings 20, 22 on one side of the lateral liner 12 and the main liner member 14 create an air tight seal that does not allow the resinous material, or air, to penetrate. However, because the liner assembly 10 is produced from two separate pieces and stitched together, the juncture of the lateral liner 12 and the main liner member 14 may not be air tight. A liquid adhesive 30 is added to supplement the juncture to produce a pliable, air tight seal between the coating side 20 of the lateral liner 12 and the coating side 22 of the main liner member 14. The adhesive is applied directly to the coatings 20, 22 to seal any gap between the two coatings, while not affecting the absorbent material.

A bottle 28 of liquid adhesive 30 is used to create an adhesive collar 32 at the juncture of the lateral liner 12 and the main liner member 14. The bottle 28 applies the liquid adhesive 30 in an uncured state that is viscous, but pours onto the coated surfaces that form the juncture between lateral liner 12 and main liner member 14. The adhesive collar 32 includes a lateral flange portion 34 that engages the outside surface of the lateral liner 12, and a main flange portion 36 that engages main liner member 14. Because of the liquid nature of the adhesive 30, the liquid can be applied where desired, and therefore the problems inherent in using tape wrapped around the juncture between the liner portions are overcome.

The liquid adhesive 30 may be a silicone, a urethane, an epoxy, a UV curable liquid, or another liquid material capable of adhering to the resin impermeable material and meeting the requirements listed below. The preferred compound for the adhesive is manufactured by DYMAX Corporation of 318 Industrial Lane, Tarrington, Conn., under Product Number 3-20809. In a preferred form, the adhesive collar 32 would meet the following conditions:
The viscosity is such that the adhesive does not run down the lateral liner 12 or off of the main liner member 14. The lateral liner 12 is usually posed with its walls in a vertical position or inclined position while the main liner member 14 is usually posed in a horizontal position.
The adhesive has the properties of being adhesive—that is it adheres to the lateral liner 12 and the main liner member 12 both before and after the curing step.
The adhesive has the properties of being sufficiently flexible to fit around the juncture so that it hugs both the lateral liner 12 and the main liner assembly 14.
The adhesive has the properties of being sufficiently elastic to permit the adhesive to stretch with the main/lateral liner 10 to engage both the lateral liner 12 and the main liner member 14.
The adhesive is thermoset so that the exothermic reaction of the resin as it cures and hardens does not affect the adhesive and cause the adhesive to separate from the main liner 14 or the lateral liner 12.
The adhesive can be extruded in a bead, applied with a trowel, or sprayed.

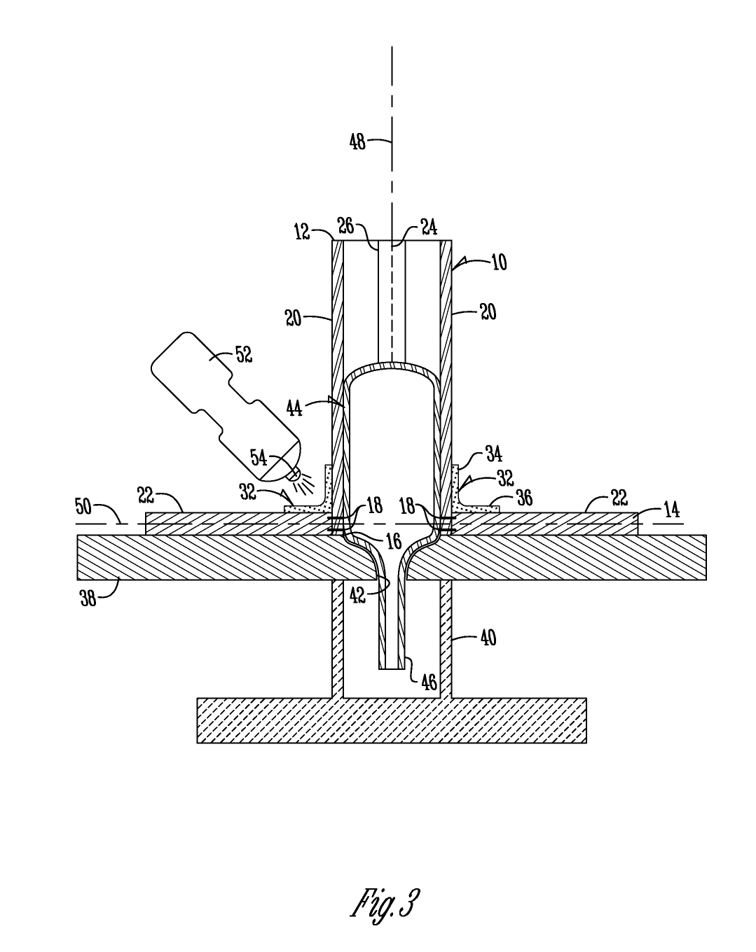

As shown in FIG. 3, curing agent holder 52 having a curing agent 54 is provided for curing the adhesive collar 32 to cause it to become a solid or a material that is rubbery like in substance. Examples of curing agents which may be used to cure the adhesive collar 32 are heat, light, including ultraviolet light, water, sonar, or electricity. While specific examples of curing agents have been given, it should be appreciated that the present invention contemplates others that accomplish the goal of curing the adhesive collar 32. Therefore, the curing agent holder 52 may be a light source, a heat source, a water source, a sound source, an electrical source or the like. The juncture is preferably cured after the liquid adhesive 30 is applied so that the adhesive collar 32 can flow to both the lateral flange 34 and the main flange 36.

Other compounds of different manufacturers or model numbers may be used which meet the specifications above as to viscosity, adherence, and flexibility. While the preferred adhesive should also have elasticity and be thermoset, these are not absolute conditions and a non-elastic or thermoplastic adhesive could be used.

A rotatable table 38 is shown in FIGS. 1 and 3. The table 38 is provided with a centralized rotatable support 40. An opening 42 is provided at the central portion or located outwardly from the central portion of table 38. An inflatable plug 44 is provided with an inflation device 46 that extends within opening 42. The size and shape of the inflatable plug 44 fits within the lateral liner 12. Preferably, the plug 44 is inflated so that it stretches the main/lateral liner assembly, particularly at the juncture between the main and lateral portions of the liner assembly 10 to simulate the stretching of the liner. The lateral liner 12 is normally undersized and then stretches to remove any wrinkles when installed.

The main/lateral liner assembly is preferably formed as follows: First the liner assembly 10 is constructed with the lateral liner 12 and the main liner 14 in separate pieces. The lateral liner 12 is then constructed with the lateral liner 12 being formed into a cylinder or other shape, and the stitches 24 are stitched together. The strip of polymer or other tape is then formed over the stitches 24 to create an airtight seal. The lateral liner 12 is inserted into the opening 16 within the main liner member 14 and the stitches 18 are inserted to join the lateral liner 12 to the main liner member 14 at the central opening 16. The angle may be at 90° or it may be at another angle to accommodate a Y-shaped pipe connection.

The liner assembly 10 is placed over a table 38 with the main liner member 14 engaging the table top and with the aperture 42 located below the lateral liner 12. The lateral liner 12 extends upwardly with the longitudinal axis extending upwardly along a longitudinal axis 48. The main liner member 14 surrounds the lateral liner 12 around central opening 16, and extends horizontally along a longitudinal axis 50.

The plug 44 is inflated by inflation device 46 to cause the liner assembly to stretch about the junction between the lateral liner 12 and the main liner member 14. The inflation device 46 inflates the plug 44 into the lateral liner 12 and causes it to stretch so that it has no wrinkles. The table 38 supports the main liner member 14 with the lateral liner 12 extending in an upstanding position. Other tables and inflation devices may be utilized without detracting from the invention.

The bottle 28 is used to spread the liquid adhesive 30 all around the juncture of lateral liner 12 and the main liner member 14 on the resin impermeable coated sides 20, 22 of the liners. This liquid adhesive 30, while in an uncured state, is somewhat viscous. The liquid adhesive 30 forms an adhesive collar 32 having a lateral flange portion 34 that engages the resin impermeable coating 20 of the lateral liner 12 and a main flange portion 36 that engages the resin impermeable coating of the main liner member 14. The adhesive clings and adheres to the coatings 20, 22 to form an air tight bond at the juncture. Finally, the adhesive collar is exposed to the curing agent 54 to cure the liquid adhesive 30 into a desired material which is thermoset, pliable, and which creates an air tight seal at the juncture of the lateral liner 12 and the main liner member 14.

Wrinkles are often present in prior art main/lateral liner assemblies. The liner assembly 10 does not have wrinkles therein, as the liner assembly 10 is pre-stretched so as to be wrinkle free at the time the liquid adhesive 30 is applied.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A method of forming a liner for use in lining the junction between a main pipe and a lateral pipe, the method comprising:
taking a liner tube having a first end, an opposite second end, and a resin impermeable coated liner tube surface opposite a resin absorbent liner tube surface;
taking a liner member having an aperture therein, and resin impermeable coated liner member surface opposite a resin absorbent liner member surface;
joining the first end of the liner tube to the liner member about the aperture in the liner member;
applying a liquid thermoset adhesive around a junction formed between the resin impermeable coated liner tube surface and the resin impermeable coated liner member surface; and
curing the adhesive.

2. The method of claim 1 wherein the liner member is a flat sheet liner.

3. The method of claim 1 wherein the liner tube extends substantially perpendicular to the liner member when joined together.

4. The method of claim 1 wherein the liquid thermoset adhesive has sufficiently high viscosity so as not to run along the liner tube or the liner member.

5. The method of claim 1 wherein the liquid thermoset adhesive is curable with exposure to a curing agent.

6. The method of claim 5 wherein the curing agent is heat.

7. The method of claim 1 further comprising forming the liner member into a tube.

8. The method of claim 1 wherein the first end of the liner tube is joined to the liner member by stitching.

9. The method of claim 1 wherein the resin impermeable coated liner tube surface and the resin impermeable coated liner member surface is a polymer.

10. The method of claim 9 wherein the resin absorbent liner tube surface and the resin absorbent liner member surface is felt.

11. A liner made by the method of claim 1.

12. A method of forming a liner for use in lining the junction between a main pipe and a lateral pipe, the method comprising:
taking a liner tube having a first end, an opposite second end, and a resin impermeable coated liner tube surface opposite a resin absorbent liner tube surface;
taking a liner member having an aperture therein and a resin impermeable coated liner member surface opposite a resin absorbent liner member surface;
joining the first end of the liner tube to the liner member about the aperture in the liner member;
inserting an inflation device through the aperture in the liner member and at least partially into the liner tube;
inflating the inflation device to stretch the liner tube radially outwardly;
applying a liquid thermoset adhesive around a junction formed between the resin impermeable coated liner tube surface and the resin impermeable coated liner member surface while the liner tube is stretched; and
curing the adhesive.

13. The method of claim 12 wherein the liner member is a flat sheet liner.

14. The method of claim 12 wherein the liner tube extends substantially perpendicular to the liner member when joined together.

15. The method of claim 12 wherein the liquid thermoset adhesive has sufficiently high viscosity so as not to run along the liner tube or the liner member.

16. The method of claim 12 wherein the liquid thermoset adhesive is curable with exposure to a curing agent.

17. The method of claim 16 wherein the curing agent is an ultraviolet light.

18. A liner made by the method of claim 12.

19. The method of claim 12 wherein the adhesive is applied around the junction as the liner tube, the liner member and the inflation device rotate around a longitudinal axis defined by the liner tube.

20. The method of claim 19 wherein the adhesive is cured as the liner tube, the liner member and the inflation device rotate around a longitudinal axis defined by the liner tube.

21. A method of forming a liner for use in lining the junction between a main pipe and a lateral pipe, the method comprising:
taking a main/lateral liner assembly comprising a liner tube having a first end, an opposite second end, and a resin impermeable coated liner tube surface opposite a resin absorbent liner tube surface and a liner member having an aperture therein and a resin impermeable coated liner member surface opposite a resin absorbent liner member surface, the first end of the liner tube being joined to the liner member about the aperture in the liner member;
inserting an inflation device through the aperture in the liner member and at least partially into the liner tube;
inflating the inflation device to stretch the liner tube radially outwardly;
applying a liquid thermoset adhesive around a junction formed between the resin impermeable coated liner tube surface and the resin impermeable coated liner member surface while the liner tube is stretched; and
curing the adhesive.

22. A liner made by the method of claim 21.

23. A method of forming a liner for use in lining the junction between a main pipe and a lateral pipe, the method comprising:
taking a main/lateral liner assembly comprising a liner tube having a first end, an opposite second end, and a resin impermeable coated liner tube surface opposite a resin absorbent liner tube surface and a liner member having an aperture therein and a resin impermeable coated liner member surface opposite a resin absorbent liner member surface, the first end of the liner tube being joined to the liner member about the aperture in the liner member;
taking a rotatable table having an inflation device extending therefrom;
inserting the inflation device through the aperture in the liner member and at least partially into the liner tube with the liner member disposed on the table;
inflating the inflation device to stretch the liner tube radially outwardly;
rotating the table with inflation device and main/lateral liner assembly;
applying a liquid thermoset adhesive around a junction formed between the resin impermeable coated liner tube surface and the resin impermeable coated liner member surface while the liner tube is stretched and rotated; and
curing the adhesive.

24. The method of claim 23 wherein the liner is cured as the liner tube is stretched and rotated on the table.

25. A liner made by the method of claim 24.

26. A method of forming a liner for use in lining the junction between a main pipe and a lateral pipe, the method comprising:
taking a main/lateral liner assembly comprising a liner tube having a first end, an opposite second end, and a resin impermeable coated liner tube surface opposite a resin absorbent liner tube surface and a liner member having an aperture therein and a resin impermeable coated liner member surface opposite a resin absorbent liner member surface, the first end of the liner tube being joined to the liner member about the aperture in the liner member;
stretching the liner tube radially outwardly around a junction formed between the liner tube and the liner member;
applying a liquid thermoset adhesive around the junction between the resin impermeable coated liner tube surface and the resin impermeable coated liner member surface while the liner tube is stretched; and
curing the adhesive.

27. A liner made by the method of claim 26.

28. A new main/lateral liner comprising:
a liner member having an aperture therein and a resin impermeable coated liner member surface opposite a resin absorbent liner member surface;
a liner tube having a first end, an opposite second end, and a resin impermeable coated liner tube surface opposite a resin absorbent liner tube surface, the first end joined to the liner member about the aperture in the liner member; and
a liquid thermoset adhesive disposed about a junction between the resin impermeable coated liner tube surface and the resin impermeable coated liner member surface.

29. The main/lateral liner of claim 28 wherein the liner tube and liner member are joined with stitches.

30. The main/lateral liner of claim 28 wherein the adhesive is cured.

31. The main/lateral liner of claim 28 wherein the liner member is formed into a tube.
